(19) United States
(12) Patent Application Publication
(10) Pub. No.: US 2026/0217209 A1
(43) Pub. Date: Jul. 30, 2026

(54) DETECTION OF PASSENGER BREATHING

(71) Applicant: VALEO COMFORT AND DRIVING ASSISTANCE, Créteil (FR)

(72) Inventors: Eloi Desbazeilles, Créteil (FR); Onur Oguz, Créteil (FR); Kawtar Es-Saghir, Créteil (FR); Georges Djokic, Créteil (FR)

(73) Assignee: VALEO COMFORT AND DRIVING ASSISTANCE, Créteil (FR)

(21) Appl. No.: 19/137,272

(22) PCT Filed: Nov. 23, 2023
(86) PCT No.: PCT/EP2023/082884

§ 371 Date: Jun. 9, 2025

(30) Foreign Application Priority Data
Dec. 9, 2022 (FR) 2213107

(51) Int. Cl. B60R 21/015; G01S 7/41; G01S 13/02

(52) U.S. Cl. CPC B60R 21/01534; B60R 21/01542; G01S 7/41; G01S 13/0209

(57) ABSTRACT

Described is a method implemented by an ultra-wide band system in a vehicle for detecting the breathing of one or more passengers. The ultra-wide band system includes one or more ultra-wide band sensors. For each ultra-wide band sensor, a radar echo signal that has an acquisition sampling frequency is acquired. Breathing search processes are performed for each radar-echo signal.

### TECHNICAL FIELD

The present disclosure relates to detection of the breathing of one or more passengers, and more particularly to a method implemented by a UWB system (UWB being the acronym of Ultra-Wide Band) to detect the breathing of one or more passengers, a computer program for a UWB system, a UWB sensor for a UWB system, and a UWB system.

### TECHNICAL BACKGROUND

Vehicles currently exist that are equipped with a UWB system comprising one or more UWB sensors that are installed in the vehicle. Such a UWB system may be capable of detecting the breathing of one or more passengers. For this purpose, the UWB system may perform, for each UWB sensor, a breathing search process based on a radar-echo signal acquired by the UWB sensor at an acquisition sampling frequency. In particular, this search process generally receives as input a sub-sample of a portion of the signal having a predetermined duration. In particular, the sub-sample may be taken at a frequency less than or equal to the acquisition sampling frequency.

However, such a search process is inefficient. Specifically, the respiratory rate of a passenger may vary depending on the type of passenger, or her/his age. For example, a child has a higher average respiratory rate than an adult, or an animal has a higher average respiratory rate than a human. Thus, to cover a sufficient frequency range, the sub-sample must be thin enough to detect high respiratory rates and of a predetermined duration long enough to detect low respiratory rates. This results in a high number of measurements needing to be stored in memory and analyzed by the search process. The search process is therefore inefficient and the amount of memory used is large.

Hence, there is a need to improve the detection of the breathing of one or more passengers.

### SUMMARY

For this purpose, a method implemented by a UWB system in a vehicle for detecting the breathing of one or more passengers is provided. The UWB system comprises one or more UWB sensors. The method comprises, for each UWB sensor, acquisition by the sensor of a radar-echo signal having an acquisition sampling frequency, and, a plurality of breathing search processes comprising a first process and a second process. The first process receives as input a first sub-sample of a portion of the signal having a first duration. The second process receives as input a second sub-sample of a portion of the signal having a second duration. The first duration is greater than the second duration and the frequency of the first sub-sample is less than the frequency of the second sub-sample.

Each process may comprise an autocorrelation analysis of the respective sub-sample with a view to detecting a repetition period of a pattern and an associated reliability score.

Each sub-sample may comprise a respective set of measurements. The number of measurements of each sub-sample may be less than or equal to 180.

The first duration may be greater than or equal to 7 seconds and/or the second duration may be less than or equal to 7 seconds.

The breathing search processes may comprise a third process. The third process may receive as input a third sub-sample of a portion of the signal having a third duration. The second duration may be greater than the third duration and the frequency of the second sub-sample may be less than the frequency of the third sub-sample.

Each process may be repeated every X seconds with X being a real number less than or equal to 2 seconds.

The method may comprise generation of an alert depending on the results of the search processes.

A computer program for a UWB system for a vehicle is also provided. The computer program comprises instructions for carrying out the method.

A UWB sensor for a UWB system is also provided. The UWB sensor is configured to implement the method.

A UWB system for a vehicle is also provided. The UWB system comprises one or more such UWB sensors. The UWB system comprises a memory on which the computer program is stored.

### BRIEF DESCRIPTION OF THE FIGURES

Non-limiting examples will be described with reference to the following figures:

FIG. 1 shows a flowchart of one example of the method.

FIG. 2 shows examples of sub-samples.

FIG. 3 shows one example of an autocorrelation analysis.

FIG. 4 shows one example of a UWB system for a vehicle.

### DETAILED DESCRIPTION

A method implemented by a UWB system in a vehicle to detect the breathing of one or more passengers is provided. The UWB system comprises one or more UWB sensors. The method comprises, for each UWB sensor, acquisition by the sensor of a radar-echo signal having an acquisition sampling frequency, and, a plurality of breathing search processes comprising a first process and a second process. The first process receives as input a first sub-sample of a portion of the signal having a first duration. The second process receives as input a second sub-sample of a portion of the signal having a second duration. The first duration is greater than the second duration and the frequency of the first sub-sample is less than the frequency of the second sub-sample.

The method improves detection of the breathing of the one or more passengers.

Specifically, the method allows performance of a search process suitable for a plurality of types of passenger. In particular, the first process is suitable for a first type of passenger having a respiratory rate in an average frequency range lower than that of a second type of passenger, for which the second process is suitable. Each process may detect a template of a (distinct) range of respiratory rates of a (distinct) type of passenger. In particular, the frequency of the first sub-sample, which is less than the frequency of the second sub-sample, allows detection of the respiratory rate of the first type of passenger. The frequency of the second sub-sample, which is greater, for its part allows detection of the respiratory rate of the second type of passenger. Each search process is therefore suitable for one particular type of passenger, this allowing efficient detection of a plurality of types of passenger by the method.

In particular, each of the first and second search processes delivers an accurate result efficiently. Specifically, since the first duration is greater than the second duration, and since the frequency of the first sub-sample is less than the frequency of the second sub-sample, the number of measurements of each sub-sample is optimized for each process. In particular, for each process, this number of measurements is optimized to guarantee a number of measurements allowing accurate detection while remaining reasonable in order to ensure computational efficiency. Each of the first and second processes is therefore efficient and accurate.

Detection of the breathing of one or more passengers may be used in the performance of one or more functionalities of the vehicle. For example, the method may comprise activation of one or more function of the vehicle depending on the results of the search processes. For example, the method may comprise closing the vehicle when none of the processes detects breathing in the vehicle, or not permitting the vehicle to close when the breathing of a passenger is detected in the vehicle by at least one process. For example, the method may comprise sending a signal initiating activation of an alarm in the case where only breathing corresponding to that of an infant is detected while the vehicle is closed. For example, the method may comprise sending a signal initiating activation of an alarm in the case where the detected breathing is progressing toward a state indicative of the driver potentially falling asleep while driving.

In examples, the method may comprise performance of one or more safety processes depending on the results of the search processes (detection or non-detection and associated reliability score). For example, the method may comprise performance of the one or more safety processes when the results indicate the presence of at least one passenger in the vehicle. For example, the method may comprise performance of the one or more safety processes when at least one breathing search process detects the breathing of a passenger in the vehicle. For example, the method may comprise performance of the one or more safety processes when a process seeking the breathing of children detects the breathing of a child, for example after a vehicle has been closed. Alternatively or additionally, the method may comprise performance of the one or more safety processes depending on a combination of the results of the search processes. For example, the method may comprise performance of the one or more safety processes when the process seeking the breathing of a child detects the presence of a child, and a process seeking the breathing of an adult does not detect the presence of an adult, for example after the vehicle has been closed. Specifically, this would mean that the child is alone in the vehicle, this representing a danger to her/him.

One example of a safety process may comprise generation of an alert. The generation of the alert may comprise, for example, sending an alarm to the owner of the vehicle, for example via her/his key or cell phone. In other examples, the generation of the alert may comprise activation of a siren or other audible signal emitted by the vehicle. Another example of a safety process may comprise maintaining a minimum and/or maximum temperature in the vehicle, for example by way of control of the air-conditioning and heating functions of the vehicle.

In other examples, the method may comprise, after detection of the breathing of the driver in the vehicle, activation of one or more functions of the vehicle such as turning on music or adjusting rear-view mirrors to suit the driver. The results of the search processes may be used in the performance of any combination of these examples of functionality.

The method may comprise a repetition of the breathing search processes, for example during the performance of the one or more functionalities of the vehicle.

Each process may be repeated every X seconds with X being a real number less than or equal to 2 seconds. Repetition of the breathing search processes allows real-time detection of the breathing of one or more passengers. Furthermore, repetition allows a risky situation to be rapidly detected in order to quickly warn the owner of the vehicle. For each process, the portion of the signal from which the sub-sample is taken may last substantially until the next repetition of the process. For example, the portion may stop at the time of the repetition, or just before. The signal portion received as input by each process may be a sliding time window that ends at the time of performance of the process, or just before (for example a time window of 5 to 10 seconds).

The method may repeat each of the processes each time a given duration that is predetermined for each process elapses. For example, the predetermined duration may be greater than or equal to the duration of the signal portion received as input by the process that is longest. In this case, each portion received as input by each breathing search process may be, for each repetition, the last portion of the signal acquired at the time of the repetition. The method may comprise repetition of each of the processes together (at the same time), or indeed a repetition with an offset between the processes.

Alternatively, the process may repeat the processes independently of one another. In this case, the method may comprise, for each process, a repetition of the breathing search process after the end of the previous repetition of the process, for example after a respective predetermined duration greater than or equal to that of the portion of the signal received as input by the process has elapsed. The portions received as input by each process during each repetition may follow in succession one after another.

For each UWB sensor, the method may perform the acquisition of the radar-echo signal and the breathing search processes at the same time. For example, the method may execute each of the breathing search processes during the acquisition of the radar-echo signal, after acquisition of the signal portion received as input by each of the breathing search processes. For each UWB sensor, the method may execute the breathing search processes at the same time, for example in parallel, or one after another, in succession.

The method may execute the steps of acquisition of the radar-echo signal and the breathing search processes successively for each of the UWB sensors of the UWB system. For example, the UWB sensors may be numbered, and the method may perform the steps of acquisition of the radar-echo signal and the breathing search processes for each of the UWB sensors in the order of the numbering of the UWB sensors, these steps for example being performed for a predetermined time for each of the UWB sensors. Alternatively, the method may consider groups of UWB sensors, and the method may perform the steps of acquisition of the radar-echo signal and the breathing search processes at the same time for the UWB sensors of a given group, and successively for each of the groups. Also alternatively, the method may execute the steps of acquisition of the radar-echo signal and the breathing search processes for all the UWB sensors of the UWB system at the same time.

The acquisition sampling frequency may be less than or equal to 250 Hz and/or greater than or equal to 20 Hz. The acquisition sampling frequency may correspond to the number of measurements per unit of time in the radar-echo signal (for example to the number of measurements per second when the frequency is expressed in Hz). Likewise, the sub-sample frequency may correspond to the number of measurements of the sub-sample per unit of time (for example to the number of measurements per second when the frequency is expressed in Hz). The acquisition sampling frequency may be greater than or equal to the sub-sample frequency of at least one breathing search process (for example, greater than or equal to the sub-sample frequency of each process). For example, the sub-sample frequency may be substantially equal to half the acquisition sampling frequency, or one-third of the acquisition sampling frequency. The acquisition sampling frequency may be substantially equal to any multiple M of the sub-sample frequency, with M being a real number. Alternatively or additionally, the sub-sample frequency of at least one breathing search process may be equal to the acquisition sampling frequency. In this case, the sub-sample of the at least one breathing search process may correspond to the sampling itself.

Each breathing search process may seek one type of passenger. Each type of passenger may correspond to one category of human persons (for example defined based on an age group) or to one category of animal (for example “dog” or “cat”). For example, the first process may seek the breathing of a human adult, and the second process may seek the breathing of a human child. Also for example, the third process may seek the breathing of a dog, or indeed a human child in a lower age range than that of the second process. The sub-sample frequency of each process may be adjusted depending on the type of person the process is seeking. For example, the sub-sample frequency may be a multiple of an average respiratory rate of the type of person sought by the process. The sub-sample frequency may for example be equal to K times the average respiratory rate, with K a real number greater than or equal to 2. Each breathing search process is able to detect breathing that has a rate in a frequency range around an average respiratory rate of the type of person sought by the process. For example, a breathing search process seeking a child may detect breathing with a rate in a frequency range around 25 bpm (which is the average rate of a child). A breathing search process seeking an adult may detect breathing with a rate in a frequency range around 12 bpm.

Each process receives one sub-sample as input. Each process may carry out the search for breathing directly on the sub-sample. In other words, each process may exclude any pre-processing, and for example may exclude (i.e., not perform) processing specific to one target frequency range and/or amplitude range. For example, each process may exclude a micro-Doppler analysis. Each process may comprise application of a function that receives as input all the measurements of the sub-sample. The function may be the same for each of the processes, or it may be different for at least two processes. The function applied by each process may not be constant for any of the measurements of the sub-sample, i.e. the function may be variable for each of the measurements of the sub-sample.

For example, each sub-sample may be a vector (xᵢ) with i ranging from 1 to N. Each process may comprise application of one function ƒ. The result delivered by the process for a sub-sample (xᵢ) may therefore be ƒ (xᵢ), i.e. the result of application of the function ƒ to the vector (xᵢ). The function ƒ may be variable for each of the measurements of the sub-sample. In other words, whatever the value of j between 1 and N, there may be two different values xⱼ₁ and xⱼ₂ for the coordinate xⱼ and one value (x)^{j} for the other coordinates (xᵢ) with i ranging from 1 to N and i≠j, for which ƒ[xⱼ₁, (x)^{j}] is different from ƒ[x_{ƒ2}, (x)^{j}].

Each process may comprise an autocorrelation analysis of the respective sub-sample with a view to detecting a repetition period of a pattern. The autocorrelation analysis may receive as input the measurements of the respective sub-sample and determine as output whether a pattern is repeated in the signal portion based on the measurements of the respective sub-sample. The repeated pattern may correspond to the breathing of the type of passenger sought by the process. The autocorrelation analysis may deliver as output a period with which the pattern is repeated and/or a repetition frequency, which may correspond to the period and rate of the detected breathing.

The autocorrelation analysis may also deliver as output a reliability score associated with the repetition period of the detected pattern. The reliability score may quantify the reliability with which repetition of the pattern is detected. The reliability score may indicate the accuracy of the detection of the breathing. For example, the reliability score may be a real number between 0 and 1, a value of 0 representing detection of low or zero reliability, and a value of 1 representing detection of absolute reliability. The autocorrelation analysis of the respective sub-sample may detect a repetition period of a pattern and an associated reliability score using the method described in section 2.2.2 of the document “On Periodicity Detection and Structural Periodic Similarity”, Michail Vlachos, Philip Yu and Vittorio Castelli, IBM T. J. Watson Research Center (URL: http://alumni.cs.ucr.edu/~mvlachos/pubs/sdm05.pdf), which is incorporated herein by reference.

For example, the first sub-sample may be a vector (xᵢ)₁ and the second sub-sample a vector (xᵢ)₂. The number of coordinates of each of the vectors (xᵢ)₁ and (xᵢ)₂ may be the same. The coordinates of the vectors (xᵢ)1 and (xᵢ)2 may represent the measurements of the first sub-sample and of the second sub-sample, respectively.

For example, each vector may comprise two coordinates for each measurement, the first coordinate indicating the measurement time and the second an amplitude of the signal at the measurement time. The coordinates of the vectors (xᵢ)₁ may represent measurements for which the measurement time is during the first duration and the coordinates of the vectors (xᵢ)₂ measurements for which the measurement time is during the second duration. The measurements represented by each of the vectors (xᵢ)₁ and (xᵢ)₂ may for example be regularly spaced over the first duration and second duration, respectively.

The autocorrelation analysis may comprise application of a function autocorrel[ ]. The first process may comprise application of the function autocorrel[ ] to the first vector (xᵢ)₁ and the result of the first process may therefore be autocorrel[(xᵢ)₁]. The second process may comprise application of the function autocorrel[ ] to the second vector (xᵢ)₂ and the result of the first process may therefore be autocorrel[(xᵢ)₂]. The function autocorrel[ ] may be a statistical function. The function autocorrel[ ] may be the autocorrelation function described in section 2.2.2 of the document “On Periodicity Detection and Structural Periodic Similarity”, Michail Vlachos, Philip Yu and Vittorio Castelli, IBM T. J. Watson Research Center (URL: http://alumni.cs. ucr.edu/~mvlachos/pubs/sdm05.pdf), which is incorporated herein by reference.

The sub-sample of each process may comprise a respective set of measurements. The number of measurements in the set may be dependent on the sub-sample frequency and on the duration of the signal portion received as input by the breathing search process. The number of measurements may be equal to the result of multiplication of the sub-sample frequency by the duration of the signal portion. The numbers of measurements of the sub-samples may be contained in the same interval. For example, the number of measurements of each sub-sample may be less than or equal to 180. The number of measurements of each sub-sample may be greater than or equal to 65.

In examples, the breathing search processes comprise a third process. The third process receives as input a third sub-sample of a portion of the signal having a third duration. The second duration is greater than the third duration and the frequency of the second sub-sample is less than the frequency of the third sub-sample. In yet other examples, the breathing search processes may form a set of N breathing search processes with N a real number. Each process i of the set may receive as input a sub-sample SEᵢ of a portion of the signal having a duration di and with a frequency ƒᵢ. The duration dᵢ and frequency ƒᵢ of each process i, starting from the second process (i>1), may be such that ƒᵢ>ƒᵢ₋₁ and dᵢ<dᵢ₋₁, with ƒᵢ₋₁ and dᵢ₋₁ the frequency and duration of sub-sample SEᵢ₋₁ of process i−1, respectively (the frequency ƒᵢ and duration dₗ of the first process being predetermined). The number of processes executed for each of the UWB sensors may be the same for each UWB sensor. Alternatively, the number of processes executed may be different for at least two UWB sensors.

In examples, the frequency of the first sub-sample may be between 1 and 12 Hz. The first duration may be greater than or equal to 7 seconds. The first duration may be less than or equal to 10 seconds. The frequency of the first sub-sample and the first duration may be between these limits in each of the two examples of implementation given below. The first process may detect the breathing of an adult human.

In a first example of implementation, the breathing search processes may consist of two breathing search processes (a first and a second process). In this first example of implementation, the frequency of the second sub-sample may be between 4 and 110 Hz. The second duration may be less than or equal to 7 seconds. The second duration may be greater than or equal to 6 seconds. In this first example, the first process is able to detect the breathing of an adult human, and the second process the breathing of a child.

In a second example of implementation, the breathing search processes may consist of three breathing search processes (a first, a second and a third process). In this second example of implementation, the frequency of the second sub-sample may be between 4 and 50 Hz. The second duration may be less than or equal to 7 seconds. The second duration may be greater than or equal to 6 seconds. The frequency of the third sub-sample may be between 15 and 110 Hz and the third duration may be between 4 and 7 seconds. In this second example, the first process is able to detect the breathing of a human adult, the second process the breathing of an adolescent child, and the third process the breathing of an infant.

Each UWB sensor may use the UWB communication protocol, for example as specified by IEEE 802.15.4. Each UWB sensor may be configured to perform the acquisition of the radar-echo signal and the breathing search processes. For example, each UWB sensor may comprise means of transmission and reception of the radar-echo signal, a processor and a memory (a non-volatile memory for example). Instructions for performing the acquisition of the radar-echo signal and the breathing search processes may be stored in the memory. The method may store the acquired radar-echo signal in the memory. The processor may perform the acquisition of the radar-echo signal and breathing search processes by executing the instructions stored in the memory and based on the radar-echo signal also stored, after acquisition, in the memory.

A computer program for a UWB system for a vehicle is also provided. The computer program may comprise instructions for performing the method. For example, the computer program may comprise instructions for each of the UWB sensors of the system. The instructions may be to execute the method when said program is executed by a UWB sensor processor. The instructions may be stored in a non-volatile memory (for example the memory of the UWB sensor).

A UWB system for a vehicle is also provided. The UWB system comprises a memory on which the computer program is stored. The UWB system may comprise a processor for executing said program. The UWB system may be configured to implement the method. The UWB system may comprise one or more UWB sensors. The UWB system may also comprise a central computer. The central computer may comprise the memory and the processor of the UWB system. The UWB system may also comprise means of connection between the central computer and/or each of the one or more UWB sensors (for example cables connecting the central computer with each of the UWB sensors).

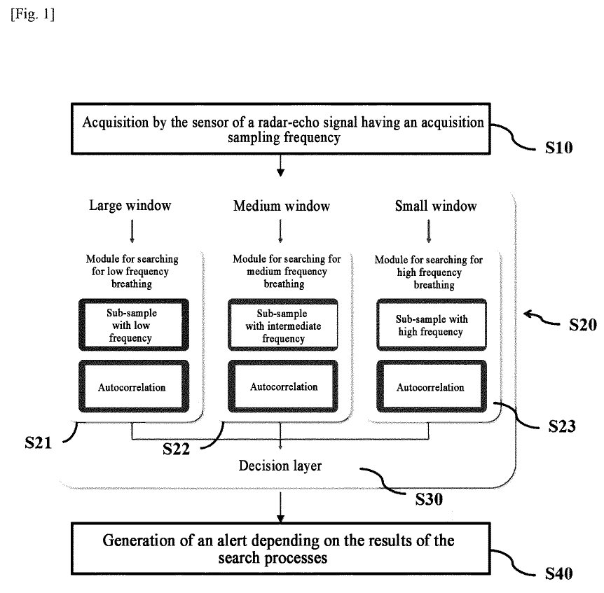

Examples will now be given with reference to FIGS. 1 to 3.

FIG. 1 shows a flowchart of one example of the method. The method is implemented by a UWB system in a vehicle to detect the breathing of one or more passengers. The UWB system comprises one or more UWB sensors. The method comprises, for each UWB sensor, acquisition S10 by the sensor of a radar-echo signal having an acquisition sampling frequency, and, a plurality of breathing search processes S20. The breathing search processes S20 consist of a first process S21, a second process S22, and a third process S23. The first process S21 receives as input a first sub-sample of a portion of the signal having a first duration. The second process S22 receives as input a second sub-sample of a portion of the signal having a second duration. The third process S23 receives as input a third sub-sample of a portion of the signal having a third duration.

The first process S21 uses a large window, i.e. the first duration is greater than the second duration and the third duration. The second process S22 uses a medium window, i.e. the second duration is less than the first duration and greater than the third duration. The third process S23 uses a small window, i.e. the third duration is less than the first duration and the second duration. The first duration is greater than the second duration and the frequency of the first sub-sample is less than the frequency of the second sub-sample. The second duration is greater than the third duration and the frequency of the second sub-sample is less than the frequency of the third sub-sample.

The first process S21 comprises a module for searching for low frequency breathing. The first process S21 therefore seeks a type of passenger having a low average rate. For example, the first process S21 is able to detect the breathing of an adult passenger. For example, the first process S21 is able to detect the breathing of a passenger having a respiratory rate less than or equal to 20 bpm (breaths per minute), and for example about 12 bpm. The first process S21 is based on a first sub-sample with a low frequency. The first process S21 comprises an autocorrelation analysis of the first sub-sample with a view to detecting a repetition period of a pattern and to determining an associated reliability score.

The second process S22 comprises a module for searching for a medium respiratory rate. The second process S22 therefore seeks a type of passenger having an average rate greater than that of the first process S21. For example, the second process S22 is able to detect the breathing of an adolescent child. For example, the second process S22 is able to detect the breathing of a passenger having a respiratory rate greater than 20 bpm and/or less than 25 bpm, and for example about 22 bpm. The second process S22 is based on a second sub-sample with an intermediate frequency. The second process S22 comprises an autocorrelation analysis of the second sub-sample with a view to detecting a repetition period of a pattern and to determining an associated reliability score.

The third process S23 comprises a module for searching for a high respiratory rate. The third process S23 therefore seeks a type of passenger having an average rate greater than that of the first process S21 and second process S22. For example, the third process S23 is able to detect the breathing of a young child (an infant for example). For example, the third process S23 is able to detect the breathing of a passenger having a respiratory rate greater than 25 bpm, and for example about 27 bpm. The third process S23 is based on a third sub-sample with a high frequency. The third process S23 comprises an autocorrelation analysis of the third sub-sample with a view to detecting a repetition period of a pattern and to determining an associated reliability score.

The method then comprises executing a decision layer based on the results of the processes. For example, the decision layer may identify a risky situation based on the results of the processes. Execution of the decision layer may for example identify the presence of a child alone in the vehicle. To do this, the method may determine that a child is alone in the vehicle when the first process, detecting adult passengers, does not detect the presence of an adult passenger in the vehicle (for example with an associated reliability score above a predetermined threshold), and at least one of the second and third processes, detecting the breathing of adolescent children or infant passengers, detects the presence of at least one adolescent child or infant passenger (for example also with an associated reliability score above a predetermined threshold).

The decision layer may also receive as input information on the vehicle. For example, the decision layer may receive as input a state of closure of the vehicle.

Identification of the risky situation by the decision layer may be conditional on this information on the vehicle. For example, the decision layer may identify a risky situation when it is determined that a child is alone in the vehicle and that the vehicle is closed. When a risky situation is identified, the method may comprise performance of one or more safety processes, such as generation of an alert.

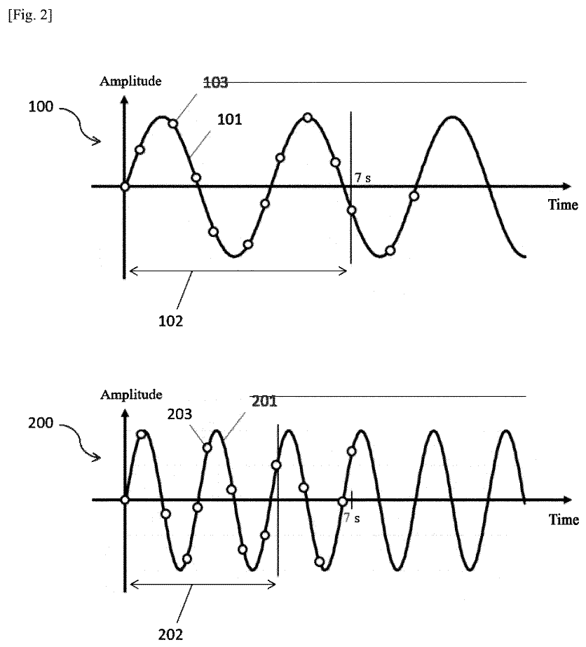

FIG. 2 shows examples of sub-samples. FIG. 2 shows a first example of a sub-sample 100 of a portion of the signal 101. This first sub-sample 100 has a first duration 102. This first sub-sample 100 may, for example, be used by the first process S21 of FIG. 1. The first sub-sample comprises a set of measurements 103. The first duration 102 represents approximately two periods of the detected breathing of the passenger. The number of measurements of the first sub-sample 100 allows detection of the breathing of an adult passenger by the first process. In particular, the number of measurements to be analyzed by the first process is not excessive, in particular given the length of the first duration 102. The frequency of the first sub-sample is configured to achieve a reasonable number of measurements to be analyzed by the first process (while having a plurality of measurements per breathing period). This makes it possible to ensure the accuracy and efficiency of the first process in respect of detection of the breathing of an adult passenger.

FIG. 2 also shows a second example of a sub-sample 200 of a portion of the signal 201. This second sub-sample 200 has a second duration 202. This second sub-sample 200 may, for example, be used by the second process S22 of FIG. 1. The second sub-sample comprises a set of measurements 203. The second duration 202 represents approximately two periods of the detected breathing of the passenger. The number of measurements of the second sub-sample 200 allows detection of the breathing of a child passenger by the second process. In particular, the second sub-sample 200 comprises a plurality of measurements, although the second duration 202 is shorter than the first duration 102, and the number of measurements makes it possible to detect the breathing of the child. The frequency of the second sub-sample is higher than that of the first process and hence the second sub-sample 200 comprises a plurality of measurements per breathing period of a child passenger (this period being shorter than that of an adult passenger). This makes it possible to ensure the accuracy and efficiency of the second process in respect of detection of the breathing of a child passenger.

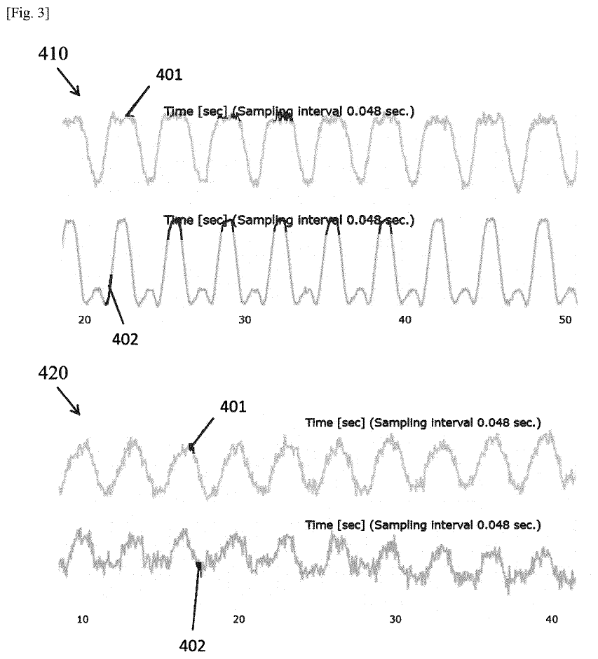

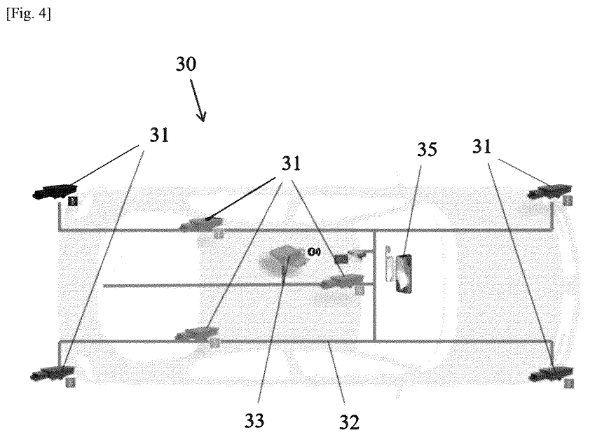

FIG. 3 shows one example of an autocorrelation analysis. In this example, the radar-echo signal to be analyzed comprises two time-dependent components:
amplitude and phase, which have been represented in FIG. 4 by the curves 401 and 402, respectively. FIG. 4 shows extracts of the two time-dependent components of radar-echo signals in two breathing scenarios 410 and 420. The autocorrelation analysis of the respective sub-sample may detect a repetition period of a pattern. The breathing patterns observed in the amplitude component generally share an underlying feature, namely a shape close to a triangular signal the high and low peaks of which have flattened to form two plateaus (which may be of different durations), and the rising slope of which is steeper (and therefore shorter in time) than the falling slope, which may have a slightly convex appearance. The autocorrelation analysis may comprise detection of a repetition of these patterns. The curves in this figure originate from a recording of breathing under conditions that were optimal for detection. In other examples, the raw radar-echo signal may contain more noise and the method may comprise filtering of the phase and amplitude of the radar-echo signal (the autocorrelation analysis may then use the filtered signal). For example, the method may comprise application of a bandpass filter, the cutoff frequencies being adjusted depending on the desired range of respiratory rates.

Each process may comprise an estimation of periodicity based on application of the autocorrelation function to the amplitude or to a complex representation of the signal. The autocorrelation function may be the autocorrelation function described in section 2.2.2 of the document “On Periodicity Detection and Structural Periodic Similarity”, Michail Vlachos, Philip Yu and Vittorio Castelli, IBM T. J. Watson Research Center (URL: http://alumni.cs.ucr.edu/~mvlachos/pubs/sdm05.pdf), which is incorporated herein by reference. Each process may deliver the value of the autocorrelation function directly as reliability score for the corresponding period.

In other examples, the method may collate information from multiple sensors (for example using clustering methods). The collation of information makes it possible to increase detection robustness and to mitigate the risk of appearance of multiples of the detected period in the estimation via the autocorrelation function.

FIG. 4 illustrates one example of a UWB system 30 of a vehicle. The UWB system 30 comprises a network comprising UWB sensors 31 and a centralized electronic control unit 33. The UWB sensors 31 are positioned at the front of the vehicle, at the rear of the vehicle or indeed inside the vehicle (in the passenger compartment for example). The network also comprises means 32 of connection (cables for example) between the UWB sensors 31 and the centralized electronic control unit 33.

The UWB system 30 is configured to implement the method. For this purpose, each UWB sensor 31 may be configured to perform the acquisition of the radar-echo signal and the breathing search processes. For example, each UWB sensor 31 may comprise means of transmission and reception of radar-echo signals, a processor and a memory (a non-volatile memory for example) on which each received radar-echo signal and instructions for executing the processes may be stored. Each UWB sensor 31 may be configured to send the results of the processes it has executed to the centralized electronic control unit 33, via the connection means 32. The processor of the centralized electronic control unit 33 may then, based on the results received from each of the UWB sensors, execute the decision layer to identify a risky situation (for example a child alone in the vehicle while the vehicle is closed) and, when such a situation is identified, generate an alert.

1. A method implemented by an ultra-wide band system in a vehicle for detecting the breathing of one or more passengers, the ultra-wide band system comprising one or more ultra-wide band sensors, the method comprising, for each ultra-wide band sensor:
acquisition of acquiring a radar-echo signal having an acquisition sampling frequency; and
performing a plurality of breathing search processes comprising a first process and a second process the first process receiving as input a first sub-sample of a portion of the radar-echo signal having a first duration the second process receiving as input a second sub-sample of a portion of the radar-echo signal having a second duration, the first duration being greater than the second duration and a frequency of the first sub-sample being less than a frequency of the second sub-sample.

2. The method as claimed in claim 1, wherein each process comprises an autocorrelation analysis of the respective sub-sample with a view to detecting a repetition period of a pattern and an associated reliability score.

3. The method as claimed in claim 1, wherein each sub-sample comprises a respective set of measurements the number of measurements of each sub-sample being less than or equal to 180.

4. The method as claimed in claim 1, wherein the first duration is greater than or equal to 7 seconds and/or the second duration is less than or equal to 7 seconds.

5. The method as claimed in claim 1, wherein the plurality of breathing search processes comprise a third process, wherein the third process comprises receiving as input a third sub-sample of a portion of the radar echo signal having a third duration, the second duration being greater than the third duration and the frequency of the second sub-sample being less than a frequency of the third sub-sample.

6. The method as claimed in claim 1, wherein each process is repeated every X seconds with X being a real number less than or equal to 2 seconds.

7. The method as claimed in claim 1, the method comprising generation of an alert depending on results of the search processes.

8. A computer program for an ultra-wide band system for a vehicle, the computer program comprising instructions for carrying out the method of claim 1.

9. An ultra-wide band sensor for an ultra-wide band system, the ultra-wide band sensor being configured to implement the method as claimed in claim 1.

10. An ultra-wide band system comprising one or more ultra-wide band sensors the ultra-wide band system comprising a memory on which the program as claimed in claim 8 is stored.
